(19) United States
(12) Patent Application Publication
(10) Pub. No.: US 2024/0393605 A1
(43) Pub. Date: Nov. 28, 2024

(54) CURVED FORK-LIKE GRATING STRUCTURE, CURVED FORK-LIKE GRATING, AND PREPARATION METHOD THEREFOR

(71) Applicant: Shanghai Institute of Optics And Fine Mechanics, Chinese Academy of Sciences, Shanghai (CN)

(72) Inventors: Yunxia JIN, Shanghai (CN); Yubo WU, Shanghai (CN); Yuxing HAN, Shanghai (CN); Fanyu KONG, Shanghai (CN); Hongchao CAO, Shanghai (CN); Yibin ZHANG, Shanghai (CN)

(21) Appl. No.: 18/789,667

(22) Filed: Jul. 30, 2024

Related U.S. Application Data
(63) Continuation of application No. PCT/CN2023/117636, filed on Sep. 8, 2023.

(30) Foreign Application Priority Data
Sep. 9, 2022 (CN) 202211103662.2
Sep. 7, 2023 (CN) 202311151009.8

(51) Int. Cl. G02B 27/09; G02B 5/18; G02B 27/44; H01S 3/00

(52) U.S. Cl. CPC G02B 27/0944; G02B 5/1861; G02B 27/0927; G02B 27/44; H01S 3/0057

(57) ABSTRACT

The curved fork-like grating is provided where curves formed by all points in the same relative positions in respective periods are distributed to be curved and fork-like, so that incident light irradiated on the curved fork-like grating is converted into Bessel-Gaussian light. Such a curved fork-like structure can be achieved by various gratings, such as a metal grating, a dielectric grating, or a metal and dielectric hybrid grating, without affecting their intrinsic characteristics, such as a diffraction efficiency, a use band, a diffraction angle, and a polarization characteristic except that a diffraction light field carries a high-order Bessel phase. Compared with a method for obtaining Bessel-Gaussian light in the prior art, the curved fork-like grating provided by the present invention is simpler in light path and appropriate for a wide band.

### CROSS-REFERENCE TO RELATED APPLICATIONS

The subject application is a continuation of PCT/CN2023/117636 filed on Sep. 8, 2023, which in turn claims priority on Chinese Patent Application No. CN202211103662.2 filed on Sep. 9, 2022, in China, and Chinese Patent Application No. CN202311151009.8 filed on Sep. 7, 2023, in China. The contents and subject matters of the PCT international stage application and Chinese priority applications are incorporated herein by reference.

### TECHNICAL FIELD

The present invention relates to the field of diffraction grating, in particular to a curved fork-like grating structure capable of converting Gaussian light into Bessel-Gaussian light, a curved fork-like grating, and a preparation method therefor.

### BACKGROUND ART

A vortex beam is a beam with vortex characteristics, a phase or wavefront of such light is spiral, and a complex amplitude contains a spiral phase term which can be expressed as exp (ilφ), wherein 1 represents a topological charge, and φ represents angular coordinates. Each photon in the vortex beam carries 1 h orbital angular momentum (OAM), and such an orbital angular momentum can be transferred to irradiated microparticles. The vortex beam has potential application values in a plurality of aspects such as optical communication, microparticle manipulation, and optical trapping. However, the ring radius of a traditional vortex beam will increase with the increase of a topological charge, and therefore, its applications in a plurality of fields are limited. In 2013, Ostrovsky et al. first proposed a concept of perfect vortex beams, and their ring diameters are irrelated to the topological charge (Opt Lett 38, 534-536 (2013)), which has received extensive attention. The perfect vortex beams are obtained from Bessel-Gaussian light by Fourier transform.

The current most common way to produce a Bessel-Gaussian light field is to load a computed hologram by using a liquid crystal spatial light modulator (SLM). However, the method is high in cost and low in diffraction efficiency, and its liquid crystal structure makes it difficult to increase a damage threshold. There is also a way to obtain high-order Bessel-Gaussian light (See Opt Lett 41, 1348-1351 (2016)) by cascading a spiral phase plate and a cone lens, thereby producing perfect vortex light. However, a light path is very complex, it is also difficult to align to an optical center, and the way can only be applied to a single wavelength.

### SUMMARY OF THE INVENTION

The technical problem to be solved by the present invention is to provide a diffraction grating capable of directly converting Gaussian light into Bessel-Gaussian light and having a characterized curved fork-like grating structure.

The solution of the present invention is described as follows.

The present invention provides a curved fork-like grating structure, wherein the curved fork-like structure comprises bending curves formed by all points in same relative positions in respective periods are bendingly distributed, and one single pare of adjacent bending curves of the bending curves comprise a fork-like structure distributed between the adjacent bending curves, and the fork-like structure converts an incident light irradiated on the curved fork-like grating structure into Bessel-Gaussian light, and a branching point of the fork-like structure is a polar point O, a distance between any point M on the grating and the point O as ρ, and a periodic density maximization direction of the curved fork-like grating structure as a polar axis Ox, a transverse distribution function of the curved fork-like grating structure in a polar coordinate system is expressed asd as:

$$ρ ( φ ) = \frac{Λ ( n + {x}_{0} ) + \frac{Λ}{2 π} l φ}{γ + cos φ} ,$$

wherein γ represents a bending factor of the bending curve, q represents a polar angle, 1 represents a topological charge value, ∧ represents an average period of the grating, n represents a periodic number difference of the point M and the point O, and x0 represents a relative position of the point M in any grating period.

In the curved fork-like grating structure of the present invention, the bending factor γ is any positive real number, the topological charge value 1 is any non-zero integer, the periodic number difference n belongs to any integer within a closed interval of positive and negative N/2, N represents a total periodic number in an overall grating aperture, and the relative position x0 is any real number within an interval [0, 1).

The present invention provides a metal curved fork-like grating, adopting the above-mentioned curved fork-like grating structure and having a longitudinal structure sequentially comprising a substrate, a top grating layer, and a metal coating from bottom to top.

The present invention provides a dielectric curved fork-like grating, adopting the above-mentioned curved fork-like grating structure and having a longitudinal structure sequentially comprising a substrate, a multilayer dielectric film, and a top grating layer from bottom to top.

The present invention provides a metal and dielectric hybrid curved fork-like grating, adopting the above-mentioned curved fork-like grating structure and having a longitudinal structure sequentially comprising a substrate, a metal and dielectric hybrid layer, and a top grating layer from bottom to top.

The present invention provides a preparation method for a curved fork-like grating, wherein the method comprises the following steps:
step (1) coaxially disposing a laser, a beam expander, a linear polarizer, and a depolarization beam splitter; disposing a reflector group, a pin-holed microscopic objective, and a first collimating lens along a reflection light path of the depolarization beam splitter; and disposing an SLM along a transmission light path of the depolarization beam splitter, and connecting the SLM to a personal computer (PC) control end;
step (2) starting the laser, and adjusting an angle of the SLM, so that light from the SLM enters and is reflected by the depolarization beam splitter to form a second beam of reflected light;
step (3) disposing a Fourier lens, a diaphragm, an attenuator, a third reflector and a collimating lens along the second beam of reflected light;
step (4) controlling the SLM by the PC control end to obtain Bessel-Gaussian light with a target bending factor γ and a topological charge value 1, and defining such a light field as an object light field;
step (5) placing a reflector perpendicular to a selected base, and adjusting an angle of the rotating base so that an object light path returns in the same way; rotating the rotating base for an angle φ/2, and adjusting a position and angle of the reflector group so that two light paths coincide, wherein at the moment, an included angle formed by the two light paths is φ, and an average period of the curved fork-like grating is expressed as:

$$Λ = \frac{λ}{2 sin ( ϕ / 2 )} ;$$

step (6) adjusting a position and angle of the Fourier lens so that a front focal plane coincides with a screen of the SLM, adjusting the diaphragm to be located on a focal plane of the lens, and adjusting an aperture to only allow first-order diffracted light to pass through the diaphragm;
step (7) rotating the polarizer, selecting a polarization direction in which the first-order diffracted light has the highest light intensity, adjusting a position of the collimating lens so that a front focal plane of the lens coincides with a plane where the diaphragm is located, and adjusting an angle of the collimating lens so that the first-order diffracted light perpendicularly passes through the center of the lens, wherein at the moment, the two light paths interfere to obtain an exposure light field; and
step (8) preparing a metal, dielectric or metal and dielectric hybrid grating, which comprises main processes: film coating, exposure in an exposure light field mentioned in steps 1 to 7, development, and etching, but is not limit to the arrangement and combination of above processes.

The present invention has the following beneficial effects:
(1) compared with a conventional straight fringe grating, the curved fork-like grating provided by the present invention can directly diffract and convert incident Gaussian light into Bessel-Gaussian light;
(2) the curved fork-like grating designed in the present invention can effectively utilize longitudinal structures of various conventional gratings and inherit their performance characteristics, can achieve a more arbitrary and wider use band than a spiral cone lens, and has a higher damage threshold and diffraction efficiency than the SLM;
(3) fringe distribution of the top grating layer of the curved fork-like grating designed in the present invention is defined, which can guide the design and preparation of the curved fork-like grating more effectively; and
(4) the present invention is suitable for various optical systems applying conventional straight fringe gratings, such as an ultra-intense and ultra-short laser compressor and a laser beam combination system and can generate Bessel-Gaussian light simply and directly.

### BRIEF DESCRIPTION OF THE DRAWINGS

FIG. 1 shows the curved fork-like grating structure of the present invention, where the transverse structure is a curved fork-like structure, the longitudinal structure directly adopts a longitudinal structure of a conventional grating, and the dotted line is a fork-like structure distributed between a pair of adjacent bending curves.

FIG. 2 shows the grating fringe obtained by adopting a curved fork-like expression provided by the present invention.

FIG. 3 is a sectional view of the longitudinal structure of the metal curved fork-like grating in one embodiment of the present invention, where the thickness of the top gold layer is 150 nm.

FIG. 4 shows the light path in one embodiment of the preparation method for the curved fork-like grating of the present invention.

FIG. 5 shows the simulation result of height distribution on all positions on the surface contour of the top grating layer within a range of a side length 2.7 mm around the center of a gold grating obtained by adopting the curved fork-like expression provided by one embodiment of the present invention, where ∧=675.68 nm, l=1, and γ=9.5×10⁻⁴.

FIG. 6A to 6D show the simulation and experiment result that diffracted light has intensity distribution changing with a propagation distance after passing through a lens of which a focal length is 50 cm in a metal curved fork-like grating actually prepared by adopting a curved fork-like distribution formula provided by one embodiment of the present invention, where a wavelength of a tested light source is 413.1 nm, an incident angle is 15° 45′, and a diffraction angle is 62°, where FIGS. 6A and 6B respectively show the simulation result that light field intensity is distributed in the front of and on a focal plane after first-order diffracted light obtained in a way that fundamental mode Gaussian light passes through a metal curved fork-like grating obtained according to the above-mentioned parameters passes through a lens of which a focal length is 50 cm; and FIGS. 6C and 6D respectively show the simulation result that light field intensity is distributed in the front of and on a focal plane after first-order diffracted light obtained in a way that fundamental mode Gaussian light passes through an actually prepared metal curved fork-like grating passes through a lens of which a focal length is 50 cm.

FIG. 7 shows the intensity distribution test result for measuring a topological charge value of a diffraction light field of an actually prepared metal curved fork-like grating by adopting the cylindrical lens method in one embodiment of the present invention, where there is a tilted dark fringe between dipolar luminous spots, which proves that the topological charge value of the diffraction light field is 1.

FIG. 8 shows the application of the chirped vortex pulse compression system in an embodiment of the present invention.

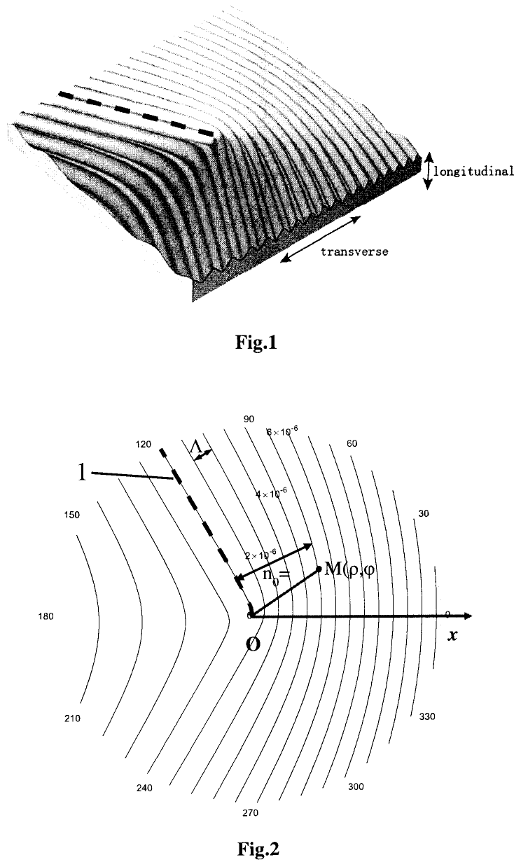

The reference numbers refer to the following structures in the drawings: 1, fork-like structure; 2, substrate; 3, top grating layer; 4, metal coating; 5, laser; 6, beam expander; 7, linear polarizer; 8, depolarization beam splitter; 9, reflective liquid crystal phase-only spatial light modulator (SLM); 10, PC control end; 11, Fourier lens; 12, adjustable aperture diaphragm; 13, third reflector; 14, second collimating lens; 15, first reflector; 16, second reflector; 17, pin-holed microscopic objective; 18, first collimating lens; 19, to-be-exposed grating sample; 20, rotating base; 21, first straight fringe diffraction grating; 22, second straight fringe diffraction grating; 23, third straight fringe diffraction grating; and 24, curved fork-like grating.

### DETAILED DESCRIPTION OF THE INVENTION

To better understand the technical solution of the present invention, it is described in more detail below in conjunction with the accompanying drawings and specific embodiments.

In one embodiment of the present invention, the metal curved fork-like grating comprises a substrate 2, a top grating layer 3, and a metal coating 4; and the curved fork-like grating is used for receiving p-polarized fundamental mode Gaussian light and obtaining high-order Bessel-Gaussian light of which a topological charge value on the +1-order diffraction order.

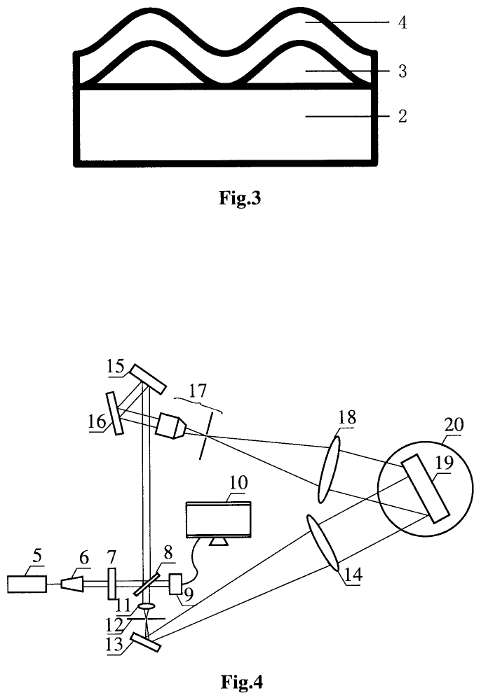

As shown in FIG. 3, substrate 2 adopts a quartz substrate, the grating layer 3 adopts photoresist having a refractive index of 1.6 and a height of 200 nm, and the metal coating 4 is made of metal gold (Au) and has a thickness of 150 nm.

The curved fork-like grating is provided where the appearance contour of the grating within a complete period is defined, a relationship between a height h and a relative position x₀ within the period is a trigonometric function relationship:

h(x₀)=[sin (2πx₀−π/2)+1]×h₀, wherein a groove depth h₀ is 200 nm.

With a center of a fork-like structure as a polar point O, a distance between any point M on the grating and the point O as ρ, and a periodic density maximization direction of the curved fork-like grating as a polar axis Ox, a transverse distribution function of the curved fork-like grating in a polar coordinate system can be expressed as:

$$ρ ( φ ) = \frac{Λ ( n + {x}_{0} ) + \frac{Λ}{2 π} l φ}{γ + cos φ} .$$

In the embodiment, a grating period A is 675.68 nm, the corresponding linearity is 1480 lines, a total length of a grating fringe direction is 50 mm, there are 37000 periods in total, and n is any integer within a closed interval of positive and negative 18500. x₀=0, that is, a curve is a line for connecting a starting point of each period. In the embodiment, the starting point of the period is a central position of a grating groove. The topological charge value l=1, that is, the number of forks on the central position of the grating is 1, and a bending parameter γ=9.5×10⁻⁴.

FIG. 4 is a schematic view of a preparation apparatus for a metal curved fork-like grating provided by the present invention. As shown in FIG. 4, the preparation apparatus for the curved fork-like grating of the present invention comprises a laser 5, a beam expander 6, a linear polarizer 7, a depolarization beam splitter 8, a reflective liquid crystal phase-only spatial light modulator (SLM) 9, a PC control end 10, a Fourier lens 11, an adjustable aperture diaphragm 12, a third reflector 13, a second collimating lens 14, a first reflector 15, a second reflector 16, a pin-holed microscopic objective 17, a first collimating lens 18, a to-be-exposed grating 19, and a rotating base 20.

The preparation method for a metal curved fork-like grating of the present invention comprises the following steps:
step (1) a laser 5, a beam expander 6, a linear polarizer 7 and a depolarization beam splitter 8 are coaxially disposed; a reflector group 15-16, a pin-holed microscopic objective 17 and a first collimating lens 18 are disposed along a reflection light path of the depolarization beam splitter 8; and an SLM 9 is disposed along a transmission light path of the depolarization beam splitter 8, and is connected to a PC control end 10;
step (2) the laser 5 is started so that reflected light from the SLM enters and is reflected by the depolarization beam splitter 8 to form a second beam of reflected light, wherein in the embodiment, a wavelength of the laser is 413 nm;
step (3) a Fourier lens 11, an adjustable aperture diaphragm 12, a third reflector 13 and a second collimating lens 14 are disposed along the second beam of reflected light;
step (4) the SLM 9 is controlled by the PC control end 10 to obtain Bessel-Gaussian light with a target bending factor γ=9.5×10⁻⁴ and a topological charge value l=1, and such a light field is defined as an object light field;
step (5) a reflector is placed perpendicular to a selected base 20, and an angle of the rotating base is adjusted so that an object light path returns in the same way; the rotating base is rotated for an angle 23° 7′17″, and a position and angle of the reflector group 15-16 are adjusted so that two light paths coincide, wherein at the moment, an average period of the curved fork-like grating is 675.68 nm;
step (6) a position and angle of the Fourier lens 11 are adjusted so that a front focal plane coincides with a screen of the SLM, the diaphragm 12 is adjusted to be located on a focal plane of the lens 11, and an aperture is adjusted to only allow first-order diffracted light to pass through the diaphragm;
step (7) the polarizer 7 is rotated, a polarization direction in which the first-order diffracted light has the highest light intensity is selected, a position of the collimating lens 14 is adjusted so that a front focal plane of the lens 14 coincides with a plane where the diaphragm 12 is located, and an angle of the collimating lens 14 is adjusted so that the first-order diffracted light perpendicularly passes through the center of the lens 14, wherein at the moment, the two light paths interfere to obtain an exposure light field; and
step (8) a metal, dielectric or metal and dielectric hybrid grating is prepared, which comprises main processes: exposure in an exposure light field mentioned in steps 1 to 7, development, and metal film coating, wherein in the embodiment, a metal film is made of gold.

FIG. 5 shows the simulation result of height distribution on all positions on a surface contour of a top grating layer of a grating within a range of a side length 2.7 mm, from which obvious curved Morie fringes can be observed.

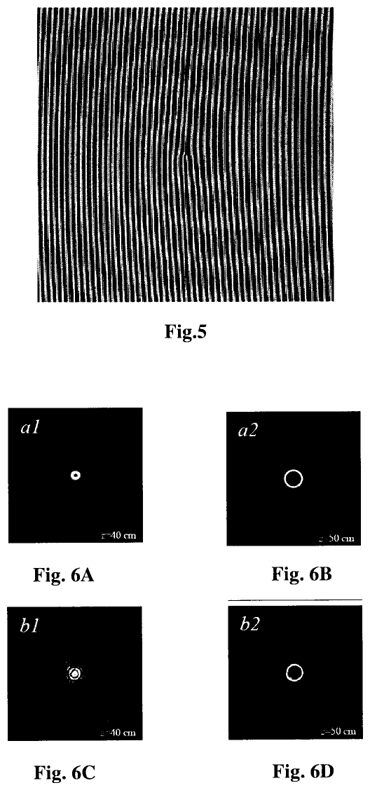

During detection, Bessel-Gaussian light passes through a lens, which more facilitates observing properties of the Bessel-Gaussian light. A light field will produce an extremely thin perfect vortex light ring irrelevant to the topological charge value on the focal plane, and intensity distribution of a concentric ring is presented on a position far from the focal plane. FIGS. 6A and 6B respectively show the simulation result that light field intensity is distributed in the front of and on a focal plane after first-order diffracted light obtained in a way that fundamental mode Gaussian light passes through a metal curved fork-like grating obtained according to the above-mentioned parameters passes through a lens of which a focal length is 50 cm.

FIGS. 6C and 6D respectively show the simulation result that light field intensity is distributed in the front of and on a focal plane after first-order diffracted light obtained in a way that fundamental mode Gaussian light passes through an actually prepared metal curved fork-like grating passes through a lens of which a focal length is 50 cm. A wavelength of a laser source used for test is 413.1 nm, an incident angle for test is 15° 45′, and a diffraction angle is 62°.

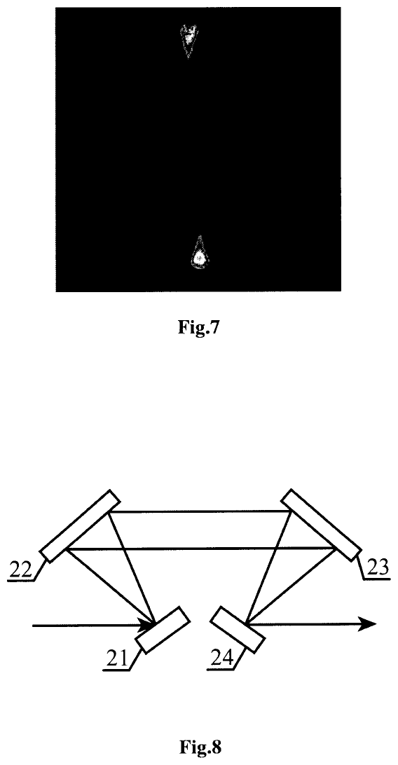

FIG. 7 shows a topological charge value of perfect vortex light shown in FIG. 6D, which is measured by using a cylindrical lens of which a focal length is 80 cm. In an intensity distribution figure, there is a dark fringe between dipolar luminous spots, from which it can be known that the topological charge value of the perfect vortex light is 1, that is, the topological charge value of the Bessel-Gaussian light produced by the metal curved fork-like grating in the present embodiment is 1.

In addition to the metal curved fork-like grating, the curved fork-like grating structure in the present invention is further appropriate for a dielectric or metal and dielectric hybrid grating.

The preparation method for the dielectric curved fork-like grating is the same as the preparation method for the metal curved fork-like grating except step 8 that the preparation processes include multilayer dielectric film coating, exposure in an exposure light field mentioned in steps 1 to 7, development, and etching.

A preparation method for the metal and dielectric hybrid curved fork-like grating is the same as the preparation method for the metal curved fork-like grating except step 8 that the preparation processes include a metal and dielectric hybrid film coating, exposure in an exposure light field mentioned in steps 1 to 7, development, and etching.

FIG. 8 is a schematic view of an application of a chirped vortex pulse compression system in an embodiment of the present invention. As shown in FIG. 8, the chirped vortex pulse compression system comprises a first straight fringe diffraction grating 21, a second straight fringe diffraction grating 22, a third straight fringe diffraction grating 23 and a curved fork-like grating 24 which are sequentially placed along a light path, wherein a grating pair composed of the curved fork-like grating and the third straight fringe diffraction grating is symmetric to a grating pair composed of the first straight fringe diffraction grating and the second straight fringe diffraction grating. The curved fork-like grating can be a metal, dielectric, or a metal and dielectric hybrid grating.

It is proven by tests that the chirped vortex pulse compression system can achieve synchronous shaping of a wavefront phase of an output pulse while performing pulse compression, thereby obtaining Laguerre-Gaussian light with a small pulse width. Each component is high in diffraction efficiency, high in damage threshold and large in working bandwidth, which creates conditions for the production of ultra-strong and ultra-fast vortex light.

Preferred implementations of the present invention are only described as above. It should be noted that those of ordinary skill in the art can further make a plurality of improvements and supplementations without departing from the method in the present invention, and these improvements and supplementations should be also considered to fall within the protective scope of the present invention.

We claim:

1. A curved fork-like grating structure, comprising
bending curves formed by all points in same relative positions in respective periods are bendingly distributed, and one single pare of adjacent bending curves of the bending curves comprise a fork-like structure distributed between the adjacent bending curves, and the fork-like structure converts an incident light irradiated on the curved fork-like grating structure into Bessel-Gaussian light, and
a branching point of the fork-like structure is a polar point O, a distance between any point M on the grating and the point O as ρ, and a periodic density maximization direction of the curved fork-like grating structure as a polar axis Ox, a transverse distribution function of the curved fork-like grating structure in a polar coordinate system is expressed as:
$$ρ ( φ ) = \frac{Λ ( n + {x}_{0} ) + \frac{Λ}{2 π} l φ}{γ + cos φ} ,$$
wherein γ represents a bending factor of the bending curve, φ represents a polar angle, l represents a topological charge value, ∧ represents an average period of the grating, n represents a periodic number difference of the point M and the point O, and x₀ represents a relative position of the point M in any grating period.

2. The curved fork-like grating structure of claim 1, wherein the bending factor γ is any positive real number, the topological charge value l is any non-zero integer, the periodic number difference n belongs to any integer within a closed interval of positive and negative N/2, N represents a total periodic number in an overall grating aperture, and the relative position x₀ is any real number within an interval [0, 1).

3. The curved fork-like grating structure of claim 1, wherein the curved fork-like grating structure is a metal, dielectric or metal and dielectric hybrid grating.

4. A metal curved fork-like grating, comprising
the curved fork-like grating structure of claim 1, and
a longitudinal structure, wherein the longitudinal structure sequentially comprises, from bottom to top, a substrate, a top grating layer, and a metal coating.

5. A dielectric curved fork-like grating, comprising
the curved fork-like grating structure of claim 1, and
a longitudinal structure, wherein the longitudinal structure sequentially comprises, from bottom to top, a substrate, a multilayer dielectric film, and a top grating layer.

6. A metal and dielectric hybrid curved fork-like grating, comprising
the curved fork-like grating structure of claim 1, and
a longitudinal structure, wherein the longitudinal structure sequentially comprises, from bottom to top, a substrate, a metal and dielectric hybrid layer, and a top grating layer.

7. A method for preparing a curved fork-like grating, comprising:
step (i) coaxially disposing a laser (5), a beam expander (6), a linear polarizer (7), and a depolarization beam splitter (8); disposing a reflector group (15-16), a pin-holed microscopic objective (17), and a first collimating lens (18) along a reflection light path of the depolarization beam splitter (8); and disposing a spatial light modulator (SLM) (9) along a transmission light path of the depolarization beam splitter (8), and connecting the SLM to a personal computer (PC) control end (10);
step (ii) starting the laser (5) so that reflected light from the SLM enters and is reflected by the depolarization beam splitter (8) to form a second beam of reflected light;
step (iii) disposing a Fourier lens (11), an adjustable aperture diaphragm (12), a third reflector (13) and a second collimating lens (14) along the second beam of reflected light;
step (iv) controlling the SLM (9) by the PC control end (10) to obtain Bessel-Gaussian light with a target bending factor γ and a topological charge value l, and defining such a light field as an object light field;
step (v) placing a reflector perpendicular to a selected base (20), and adjusting an angle of the rotating base so that an object light path returns in the same way; rotating the rotating base for an angle φ/2, and adjusting a position and angle of the reflector group (15-16) so that two light paths coincide, wherein at the moment, an included angle formed by the two light paths is φ, and an average period of the curved fork-like grating is expressed as:
$$Λ = \frac{λ}{2 sin ( ϕ / 2 )} ,$$
step (vi) adjusting a position and angle of the Fourier lens (11) so that a front focal plane coincides with a screen of the SLM, adjusting the diaphragm (12) to be located on a focal plane of the lens (11), and adjusting an aperture to only allow first-order diffracted light to pass through the diaphragm;
step (vii) rotating the polarizer (7), selecting a polarization direction in which the first-order diffracted light has the highest light intensity, adjusting a position of the collimating lens (14) so that a front focal plane of the lens (14) coincides with a plane where the diaphragm (12) is located, and adjusting an angle of the collimating lens (14) so that the first-order diffracted light perpendicularly passes through the center of the lens (14), wherein at the moment, the two light paths interfere to obtain an exposure light field; and
step (viii) preparing a metal, dielectric, or metal and dielectric hybrid grating, film coating, exposing the metal, dielectric, or metal and dielectric hybrid grating in an exposure light field obtained from steps (i) to (viii), developing, and etching, wherein the steps of preparing, film coating, exposing, developing, and etching are not limited to a particular order, arrangement, and combination.

8. A chirped vortex pulse compression system, comprising
a first straight fringe diffraction grating (21),
a second straight fringe diffraction grating (22),
a third straight fringe diffraction grating (23),
the curved fork-like grating of claim 4,
wherein the first, second, and third straight diffraction gratings (21, 22, 23) are sequentially placed along a light path, and
a grating pair composed of the curved fork-like grating and the third straight fringe diffraction grating is symmetric to a grating pair composed of the first straight fringe diffraction grating and the second straight fringe diffraction grating.

9. A chirped vortex pulse compression system, comprising
a first straight fringe diffraction grating (21),
a second straight fringe diffraction grating (22),
a third straight fringe diffraction grating (23),
the curved fork-like grating of claim 5,
wherein the first, second, and third straight diffraction gratings (21, 22, 23) are sequentially placed along a light path, and
a grating pair composed of the curved fork-like grating and the third straight fringe diffraction grating is symmetric to a grating pair composed of the first straight fringe diffraction grating and the second straight fringe diffraction grating.

10. A chirped vortex pulse compression system, comprising
a first straight fringe diffraction grating (21),
a second straight fringe diffraction grating (22),
a third straight fringe diffraction grating (23),
the curved fork-like grating of claim 6,
wherein the first, second, and third straight diffraction gratings (21, 22, 23) are sequentially placed along a light path, and
a grating pair composed of the curved fork-like grating and the third straight fringe diffraction grating is symmetric to a grating pair composed of the first straight fringe diffraction grating and the second straight fringe diffraction grating.
